(19) United States
(12) Patent Application Publication
(10) Pub. No.: US 2024/0094614 A1
(43) Pub. Date: Mar. 21, 2024

(54) OPTICAL MODULE AND PROJECTOR

(71) Applicant: SONY GROUP CORPORATION, TOKYO (JP)

(72) Inventor: KAZUMASA KANEDA, TOKYO (JP)

(21) Appl. No.: 18/260,970

(22) PCT Filed: Dec. 24, 2021
(86) PCT No.: PCT/JP2021/048371

§ 371 Date: Jul. 11, 2023

(30) Foreign Application Priority Data
Jan. 20, 2021 (JP) 2021-006955

(51) Int. Cl. G03B 21/20; G03B 21/16

(52) U.S. Cl. CPC G03B 21/204; G03B 21/16; G03B 21/2073

(57) ABSTRACT

An optical module according to an embodiment of the present disclosure includes: a light source section that emits excitation light; a wavelength conversion section that emits illumination light including first color light, second color light, and third color light having different wavelength bands by absorption and reflection of the excitation light; an optical element that splits the illumination light into the first color light, the second color light, and the third color light; a first reflective light modulation element that modulates the first color light; and a second reflective light modulation element that modulates the second color light and the third color light.

### TECHNICAL FIELD

The present disclosure relates to an optical module including, for example, two light valves and a reflective wavelength conversion element as a light source, and a projector including the optical module.

### BACKGROUND ART

Examples of types of projectors performing full-color display include a single-plate type using one common light valve for respective color light beams of R (red), G (green), and B (blue), a three-plate type using different light valves for three color light beams, and the like (see PTLs 1 to 4). Meanwhile, when continuously causing blue light having a short wavelength to be incident on one light valve, the light valve is deteriorated. PTL 1 proposes using two light valves for blue light to thereby extend the lives of the light valves.

### CITATION LIST

### Patent Literature

PTL 1: Japanese Unexamined Patent Application Publication No. 2018-13655
PTL 2: Japanese Unexamined Patent Application Publication No. 2001-324762
PTL 3: Japanese Unexamined Patent Application Publication No. 2008-165058
PTL 4: Japanese Unexamined Patent Application Publication No. 2006-343721

### SUMMARY OF THE INVENTION

Incidentally, a projector using two light valves is required to have improved color reproducibility.

It is therefore desirable to provide an optical module and a projector that make it possible to improve color reproducibility.

An optical module according to an embodiment of the present disclosure includes: a light source section that emits excitation light; a wavelength conversion section that emits illumination light including first color light, second color light, and third color light having different wavelength bands by absorption and reflection of the excitation light; an optical element that splits the illumination light into the first color light, the second color light, and the third color light; a first reflective light modulation element that modulates the first color light; and a second reflective light modulation element that modulates the second color light and the third color light.

A projector according to an embodiment of the present disclosure includes the optical module according to an embodiment of the present disclosure.

In the optical module according to an embodiment of the present disclosure and the projector according to an embodiment of the present disclosure, illumination light including the first color light, the second color light, and the third color light that are emitted from the wavelength conversion section and have different wavelength bands is split by an optical element into the first color light, the second color light, and the third color light, and the first color light is guided to the first reflective light modulation element and the second color light and the third color light are guided to the second reflective light modulation element. This allows for an increase in a color gamut.

### BRIEF DESCRIPTION OF THE DRAWINGS

FIG. 1 is an outline view of a configuration example of an optical module according to an embodiment of the present disclosure and a projector including the optical module.

FIG. 2 is a schematic plane view of an example of a configuration of a wavelength conversion section illustrated in FIG. 1.

FIG. 3 is a diagram illustrating an example of characteristics of a notch filter illustrated in FIG.

FIG. 4 is a diagram illustrating an example of wavelength selective characteristics of a wavelength selective polarization rotator illustrated in FIG. 1.

FIG. 5 is a schematic view of an example of a method for cooling two light valves according to a modification example of the present disclosure.

FIG. 6 is a schematic view of another example of the method for cooling two light valves according to the modification example of the present disclosure.

### MODES FOR CARRYING OUT THE INVENTION

In the following, description is given in detail of embodiments of the present disclosure with reference to the drawings. The following description is merely a specific example of the present disclosure, and the present disclosure should not be limited to the following aspects. Moreover, the present disclosure is not limited to arrangements, dimensions, dimensional ratios, and the like of each component illustrated in the drawings. It is to be noted that the description is given in the following order.

### 1. Embodiment

(An example of an optical module in which illumination light is split into first color light, second color light, and third color light to be guided to two light valves)
2. Modification example
(Another example of a method for cooling two light valves)

### 1. EMBODIMENT

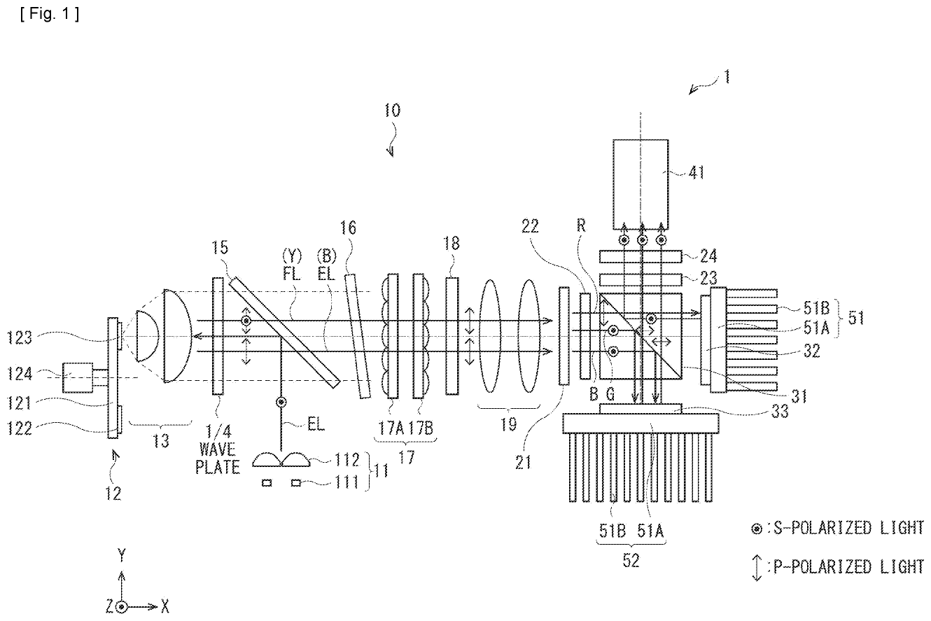

FIG. 1 illustrates a configuration example of an optical module (an optical module 10) according to an embodiment of the present disclosure and a projector (a projector 1) including the optical module. The projector 1 is a reflective 2LCD type projection display apparatus that performs light modulation using two reflective liquid crystal panels (Liquid Crystal Display: LCD).

### [Configuration of Optical Module]

The optical module 10 includes, for example, a light source section 11, a wavelength conversion section 12, a polarization beam splitter (PBS) 31, a first light valve 32, and a second light valve 33. The optical module 10 further includes a light-condensing lens 13, a ¼ wave plate 14, a wavelength selective PBS 15, a notch filter 16, a lens array 17, a PS converter 18, a relay lens 19, a polarizer 21, a first wavelength selective polarization rotator 22, a second wavelength selective polarization rotator 23, a polarizer 24, and a projection lens 41.

The light source section 11 corresponds to a specific example of a “light source section” of the present disclosure. The light source section 11 includes one or multiple light sources 111 and lenses 112 disposed to face the respective light sources 111. The light source 111 is, for example, a solid-state light source that emits light of a predetermined wavelength band, and is provided to excite a phosphor particle included in a phosphor layer 122 of the wavelength conversion section 12. As the light source 111, for example, a semiconductor laser (Laser Diode: LD) can be used. In addition, a light-emitting diode (Light Emitting Diode: LED) may be used.

The light source section 11 emits, as excitation light EL, light (blue light B) of a wavelength band corresponding to a blue color having a wavelength of 400 nm to 470 nm, for example. It is to be noted that, as used herein, the light of a predetermined wavelength band refers to light having a luminous intensity peak in that wavelength band.

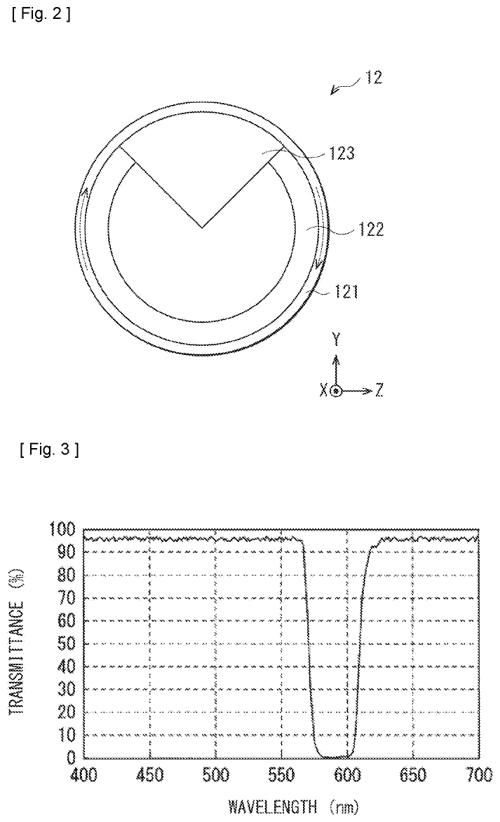

The wavelength conversion section 12 corresponds to a specific example of a “wavelength conversion section” of the present disclosure. The wavelength conversion section 12 absorbs light (excitation light EL) emitted from the light source section 11 to convert it into light (fluorescence FL) of a different wavelength band and emits the light. The wavelength conversion section 12 is a so-called reflective wavelength conversion element, and is configured to reflect and emit the fluorescence FL generated by incidence of the excitation light EL. As illustrated in FIG. 2, in the wavelength conversion section 12, for example, a light-reflective support substrate 121 having light reflectivity is provided with the phosphor layer 122 and a reflective polarization maintaining diffuser plate 123. This phosphor layer 122 corresponds to a specific example of a “phosphor region” of the present disclosure, and the polarization maintaining diffuser plate 123 corresponds to a specific example of a “reflective region” of the present disclosure.

The support substrate 121 is provided to support the phosphor layer 122 and the polarization maintaining diffuser plate 123, and has a disk shape, for example. The support substrate 121 has functions not only as a reflective member but also as a heat dissipation member. The support substrate 121 can be formed by a metal material having high thermal conductivity, for example. In addition, the support substrate 121 may be formed using a metal material or a ceramic material enabling specular working, for example. This suppresses temperature rise in the phosphor layer 122, and thus improves efficiency in extraction of light (fluorescence FL) in the wavelength conversion section 12.

The phosphor layer 122 includes multiple phosphor particles, and is excited by the excitation light EL to emit light (fluorescence FL) of a wavelength band different from a wavelength band of the excitation light EL. The phosphor layer 122 is formed in a plate-like shape by a so-called ceramic phosphor or a binder phosphor, for example. The phosphor layer 122 includes, for example, phosphor particles that each emit light (fluorescence FL (yellow light Y)) of a wavelength band corresponding to a yellow color by being excited by, for example, blue light B (excitation light EL) emitted from the light source section 11. Examples of such phosphor particles include a YAG (Yttrium-Aluminum-Garnet)-based material. The phosphor layer 122 may further include semiconductor nanoparticles such as quantum dots, organic pigments, or the like.

The polarization maintaining diffuser plate 123 does not have a polarization action, but has a reflection action with respect to light of a predetermined wavelength band (e.g., blue light B). Consequently, in the present embodiment, the excitation light EL as blue light B is emitted as a portion of illumination light from the wavelength conversion section 12.

The wavelength conversion section 12 is, for example, a so-called phosphor wheel that is rotatable about a rotational axis (e.g., an axis J124). In the phosphor wheel, a motor 124 (drive section) is linked to the center of the support substrate 121, and the support substrate 121 is rotatable about the axis J124 in an arrow direction indicated in FIG. 2, for example, by driving force of the motor 124. In the phosphor wheel, the phosphor layer 122 is continuously formed in a rotational circumferential direction of the support substrate 121, for example, and the polarization maintaining diffuser plate 123 is provided to divide the continuous phosphor layer 122. In the phosphor wheel, rotation of the support substrate 121 causes an irradiation position of the excitation light EL to be temporally changed (moved) at a speed corresponding to the number of rotations. This allows the wavelength conversion section 12 to emit time-averaged white light resulting from temporal repetition of yellow, blue, yellow, blue . . . , as the illumination light.

The light-condensing lens 13 is configured by one or multiple lenses. The light-condensing lens 13 is disposed between the wavelength conversion section 12 and the ¼ wave plate 14. The light-condensing lens 13 condenses the excitation light EL on a predetermined spot diameter to cause the excitation light EL to be incident on the wavelength conversion section 12, and converts the phosphor FL emitted from the wavelength conversion section 12 into collimated light to guide the collimated light to the ¼ wave plate 14.

The ¼ wave plate 14 converts linearly polarized light into circularly polarized light for outputting, and is disposed between the light-condensing lens 13 and the wavelength selective PBS 15.

The wavelength selective PBS 15 splits light of a predetermined wavelength band on the basis of a polarization direction. The wavelength selective PBS 15 selectively reflects blue light of S-polarized light, for example. The wavelength selective PBS 15 is disposed between the ¼ wave plate 14 and the notch filter 16, and is disposed on a position facing the light source section 11. This allows the excitation light EL of the S-polarized light emitted from the light source section 11 to be reflected toward the wavelength conversion section 12.

The notch filter 16 selectively reflects light of a predetermined wavelength band and transmits light of another wavelength band, and has characteristics as illustrated in FIG. 3, for example. The notch filter 16 is disposed between the wavelength selective PBS 15 and the lens array 17. The notch filter 16 is disposed to be inclined at an angle of, for example, about 3° relative to an optical path of illumination light including the fluorescence FL and the excitation light EL emitted from the wavelength conversion section 12 and transmitted through the wavelength selective PBS 15. This enables the light reflected by the notch filter 16 to be efficiently eliminated from the optical path of the illumination light. In addition, it is possible to prevent light reflected by the notch filter 16 from being incident again on the wavelength conversion section 12. This makes it possible to reduce a temperature increase in the wavelength conversion section and suppress a decrease in the conversion efficiency as well as deterioration in the phosphor layer 122.

The lens array 17 is designed to homogenize illumination distribution of incident light. The lens array 17 is, for example, a pair of fly-eye lenses 17A and 17B having multiple microlenses arranged two-dimensionally, and is disposed between the notch filter 16 and the PS converter 18.

The PS converter 18 aligns a polarization state of incident ligh in one direction for outputting. Here, P-polarized light is transmitted as it is, and S-polarized light is converted into P-polarized light. The PS converter 18 is disposed between the lens array 17 and the relay lens 19. Illumination light transmitted through the PS converter 18 is guided to the polarizer 21 via the relay lens 19.

Each of the polarizers 21 and 24 transmits only linearly polarized light in a particular direction. Here, the polarizer 21 transmits only P-polarized light, whereas the polarizer 24 transmits only S-polarized light. The polarizer 21 is disposed between the relay lens 19 and the first wavelength selective polarization rotator 22. The polarizer 24 is disposed between the second wavelength selective polarization rotator 23 and the projection lens 41.

The first wavelength selective polarization rotator 22 and the second wavelength selective polarization rotator 23 each selectively rotate and output polarized light of a predetermined wavelength band. The first wavelength selective polarization rotator 22 corresponds to a specific example of a “first wavelength selective polarization conversion element” of the present disclosure, and is disposed between the polarizer 21 and a first surface S1 of a PBS 31. The second wavelength selective polarization rotator 23 corresponds to a specific example of a “second wavelength selective polarization conversion element” of the present disclosure, and is disposed between a third surface S3 of the PBS 31 and the polarizer 24.

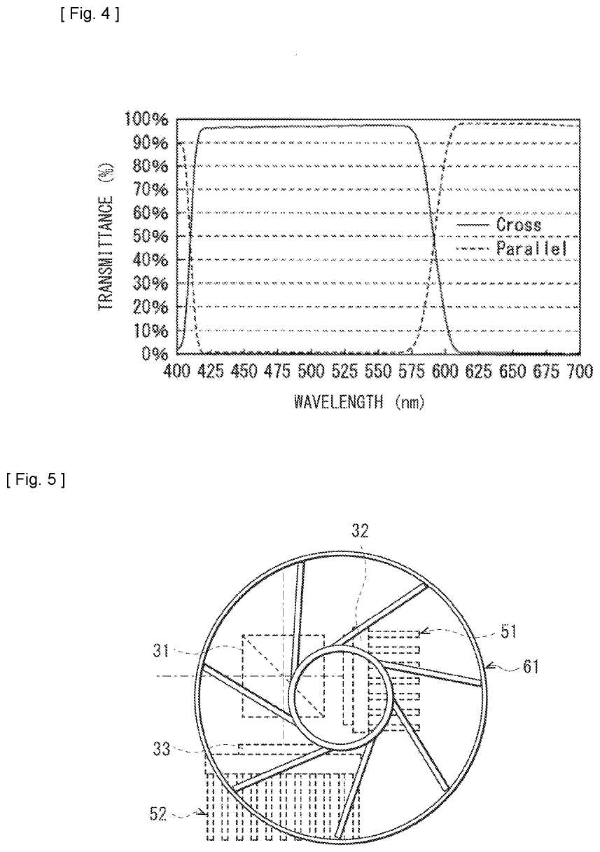

The first wavelength selective polarization rotator 22 has wavelength selectivity as illustrated in FIG. 4, for example, and transmits light (red light R) of a wavelength band corresponding to a red color, among illumination light (P-polarized light) incident from the polarizer 21, as it is, whereas the first wavelength selective polarization rotator 22 converts light (green light G) of a wavelength band corresponding to a green color and light (blue light B) of a wavelength band corresponding to a blue color into S-polarized light for outputting toward the PBS 31.

The second wavelength selective polarization rotator 23 has wavelength selectivity similar to that of the first wavelength selective polarization rotator 22, and transmits the red light R (S-polarized light) outputted from the third surface S3 of the PBS 31 as it is, whereas the second wavelength selective polarization rotator 23 converts the green light G and the blue light B (both P-polarized light) into S-polarized light for outputting toward the polarizer 24.

The PBS 31 corresponds to a specific example of an “optical element” of the present disclosure, and splits incident light depending on a polarization component. The PBS 31 includes, for example, an optical functional film that reflects or transmits incident light depending on a polarization component, and two prisms attached to each other with the optical functional film interposed therebetween. Here, the PBS 31 is configured to reflect an S-polarization component and transmit a P-polarization component. The PBS 31 has, for example, four surfaces (the first surface S1, a second surface S2, the third surface S3, and a fourth surface S4). Among the four surfaces, the first surface S1 and the second surface S2 are disposed to face each other with the above-described optical functional film interposed therebetween; the third surface S3 and the fourth surface S4 are disposed to face each other with the above-described optical functional film interposed therebetween, and are disposed to be adjacent to the first surface S1 and second surface S2 between the first surface S1 and the second surface S2. In the present embodiment, the first surface S1 serves as an incident surface of illumination light, and the third surface S3 serves as an output surface of illumination light. The first wavelength selective polarization rotator 22 and the second wavelength selective polarization rotator 23 are disposed to face the first surface S1 and the third surface S3, respectively.

The first light valve 32 and the second light valve 33 each modulate and output incident light, and modulate and output illumination light on the basis of a picture signal, for example. The first light valve 32 corresponds to a specific example of a “first light modulation element” of the present disclosure, and is disposed to face the second surface S2 of the PBS 31. The second light valve 33 corresponds to a specific example of a “second light modulation element” of the present disclosure, and is disposed to face the fourth surface S4 of the PBS 31. In the present embodiment, the first light valve 32 and the second light valve 33 are configured using a reflective liquid crystal, for example. Therefore, each light incident on the first light valve 32 and the second light valve 33 is changed into polarized light in a state of being orthogonal to incident polarized light, and is outputted.

The projection lens 41 is configured by one or multiple lenses. The projection lens 41 is disposed on a subsequent stage of the polarizer 24, and projects, as picture light, the light modulated by the first light valve 32 and the second light valve 33 via a PBS 41 onto a screen (unillustrated) or the like to form an image.

### [Operating Principle of Optical Module]

In the present embodiment, blue light (B) mainly including S-polarized light is emitted as the excitation light EL from the light source section 11, for example, in a Y-axis direction. The excitation light EL emitted from the light source section 11 is reflected by the wavelength selective PBS 15 toward the wavelength conversion section 12, for example, in an X-axis direction. The excitation light EL reflected by the wavelength selective PBS 15 is first incident on the ¼ wave plate 14. The ¼ wave plate 14 converts, in terms of a polarization direction of the excitation light EL, from S-polarized light to circularly polarized light to output it toward the light-condensing lens 13. The excitation light EL having been incident on the light-condensing lens 13 is condensed on a predetermined spot diameter, and is outputted toward the wavelength conversion section 12.

The excitation light EL having been indent on the wavelength conversion section 12 excites phosphor particles in the phosphor layer 122. In the phosphor layer 122, phosphor particles are excited by irradiation of the excitation light EL radiation to emit the fluorescence FL. The fluorescence FL is the yellow light Y in a non-polarization state including the S-polarization component and the P-polarization component, and is emitted toward the light-condensing lens 13. In addition, the excitation light EL having been incident on the wavelength conversion section 12 is emitted (reflected) toward the light-condensing lens 13 while holding a polarization direction in the polarization maintaining diffuser plate 123. In the wavelength conversion section 12, as described above, the rotation of the support substrate 121 causes the irradiation position of the excitation light EL to be temporally changed (moved) at a speed corresponding to the number of rotations, thus allowing time-averaged white light resulting from temporal repetition of yellow, blue, yellow, blue . . . to be emitted as the illumination light.

The fluorescence FL and the excitation light EL emitted from the wavelength conversion section 12 are each converted into substantially collimated light to be emitted toward the ¼ wave plate 14. The fluorescence FL having been incident on the ¼ wave plate 14 is outputted toward the wavelength selective PBS 15 while remaining the non-polarized state. The excitation light EL having been incident on the ¼ wave plate 14 is converted, in terms of the polarization direction, from the circularly polarized light to the P-polarized light to be outputted toward the wavelength selective PBS 15. The fluorescence FL and the excitation light EL outputted from the ¼ wave plate 14 are each transmitted through the wavelength selective PBS 15 to be incident on the notch filter 16.

In the notch filter 16, among the incident fluorescence FL and excitation light EL, light of a wavelength band at which the rotational direction of the polarized light, of the first wavelength selective polarization rotator disposed in subsequent stage, is switched (intermediate wavelength band) is reflected. Here, for example, light of a wavelength band of about 575 nm to about 620 nm is reflected, and light of another wavelength band is transmitted through the notch filter 16 to be outputted toward the lens array 17.

The illumination light outputted from the notch filter 16 is transmitted through the lens array 17 to be outputted toward the PS converter 18. In the PS converter 18, the S-polarization component of the fluorescence FL transmitted through the notch filter 16 is converted into the P-polarization component to be outputted, and the excitation light EL of the P-polarized light is outputted as it is. This allows the polarization state of the illumination light to be uniformed to the P-polarized light.

The illumination light outputted from the PS converter 18 is guided to the polarizer 21 via the relay lens 19. In the polarizer 21, a polarization component other than the P-polarization component included in the illumination light is blocked, and only the P-polarization component is outputted toward the first wavelength selective polarization rotator 22.

The first wavelength selective polarization rotator 22 transmits light (red light R) of a wavelength band corresponding to a red color, among illumination light incident from the polarizer 21, as it is as the P-polarized light, whereas the first wavelength selective polarization rotator 22 converts light (green light G) of a wavelength band corresponding to a green color and light (blue light B) of a wavelength band corresponding to a blue color into S-polarized light for outputting toward the first surface S1 of the PBS 31. The red light R corresponds to a specific example of a “first color light” of the present disclosure. The green light G corresponds to a specific example of a “second color light” of the present disclosure. The blue light B corresponds to a specific example of a “third color light” of the present disclosure. The red light R, the green light G, and the blue light B outputted from the first wavelength selective polarization rotator 22 are split in the PBS 31 on the basis of polarization directions thereof. Specifically, the red light R, which is P-polarized light, is transmitted through the optical functional film, and is guided to the first light valve 32 disposed to face the second surface S2 of the PBS 31. The green light G and the blue light B, which are each S-polarized light, are reflected at the optical functional film, and guided to the second light valve 33 disposed to face the fourth surface S4 of the PBS 31.

The red light R having been incident on the first light valve 32 is modulated on the basis of a picture signal, converted, in terms of the polarization direction, from P-polarized light to S-polarized light to be outputted toward the PBS 31, and reflected at the optical functional film of the PBS 31 to be outputted from the third surface S3 toward the second wavelength selective polarization rotator 23. The green light G and the blue light B having been incident on the second light valve 33 are each modulated on the basis of a picture signal, and converted, in terms of the polarization direction, from S-polarized light to P-polarized light to be outputted toward the PBS 31, transmitted through an optical thin film to be outputted from the third surface S3 toward the second wavelength selective polarization rotator 23.

The second wavelength selective polarization rotator 23 converts the red light R of S-polarized light, among the red light R, the green light G and the blue light B outputted from the PBS 31, as it is, and converts the green light G and the blue light B of P-polarized light into P-polarized light for outputting toward the polarizer 24. In the polarizer 24, a polarization component other than the P-polarization component included in the red light R, the green light G, and the blue light B is blocked, and only the P-polarization component is outputted toward the projection lens 41. This makes it possible to project a picture having high contrast and a wide color gamut.

It is to be noted that FIG. 1 gives the example in which the PS converter 18 outputs illumination light uniformed to P-polarized light, but this is not limitative; the PS converter 18 may output illumination light uniformed to S-polarized light. In that case, for example, the first wavelength selective polarization rotator 22 converts the red light R from S-polarized light to P-polarized light, and transmits the green light G and the blue light B while allowing the light beams to remain as S-polarized light. This allows the red light R to be transmitted through the optical functional film of the PBS and to be guided to the first light valve 32 disposed to face the second surface S2 of the PBS 31. The green light G and the blue light B are reflected at the optical functional film, and guided to the second light valve 33 disposed to face the fourth surface S4 of the PBS 31.

### [Heat Dissipation Mechanism of Optical Module]

A first heat sink 51 and a second heat sink 52 are provided on surfaces on sides opposite to incident surfaces of the first light valve 32 and the second light valve 33, respectively. The first heat sink 51 and the second heat sink 52 are provided for adjusting temperatures of the first light valve 32 and the second light valve 33.

The first heat sink 51 corresponds to a specific example of a “first heat dissipation member” of the present disclosure, and includes, for example, a support member 51A and multiple heat dissipation fins 51B erected on the support member 51A. The second heat sink 52 corresponds to a specific example of a “second heat dissipation member” of the present disclosure, and includes, for example, a support member 52A and multiple heat dissipation fins 52B erected on the support member 52A, in the same manner as the first heat sink 51. In addition, the second heat sink 52 has a heat dissipation area larger than that of the first heat sink 51, and is configured to have a heat dissipation performance higher than that of the first heat sink 51.

Generally, in consideration of the white balance of picture light, the light amount ratio among the red light R, the green light G and the blue light B is, for example, R:G:B=1.0:1.4:1.0. For example, in a case where two light valves A and B are used to cause the red light R to be incident on the light valve A and the green light G to be incident on the light valve B separately and cause the blue light B to be split to be incident on the light valves A and B, the light amount ratio is 1.5:1.9. Meanwhile, as in the present embodiment, when the blue light B is entirely incident on the light valve B on a side of the green light G, the light amount ratio is 1.0:2.4, thus resulting in a doubled or more incident energy difference (difference in calorific value) therebetween.

Therefore, in the present embodiment, the second heat sink 51 is provided on the surface on the side opposite to the incident surface of the first light valve 32. The second heat sink 52 having a heat dissipation performance higher than that of the first heat sink 51 is provided on the surface on the side opposite to the incident surface of the second light valve 33. That is, cooling efficiency is set in an asymmetric state between the first light valve 32 and the second light valve 33. This suppresses a temperature rise of the second light valve 33, thus making it possible to operate both of the first light valve 32 and the second light valve 33 within a proper temperature range.

### [Workings and Effects]

In the optical module 10 of the present embodiment, the PBS 31 splits illumination light emitted from the wavelength conversion section 12 into the first color light (red light R), and the second color light (green light G) and the third color light (blue light B), and guides the red light R to the first light valve 32 and guides the green light G and the blue light B to the second 33. This achieves an increase in the color gamut. This is described below.

In recent years, there has been a demand for a projector that is small in size and has high luminance. In order to achieve the small-sized and high-luminance projector, it is essential to develop an optical configuration excellent in efficiency of light utilization.

As described above, examples of types of projectors performing full-color display include a single-plate type using one common light valve for respective color light beams of R (red), G (green), and B (blue), a three-plate type using different light valves for three color light beams, and the like. However, it is generally difficult to achieve a smaller size in the three-plate type projector. Meanwhile, the single-plate type projector is advantageous for a smaller size, but generally adopts a time-sequential system, thus causing light emission time of respective colors to be limited, which makes it difficult to achieve higher luminance. In a case where the single plate type and a phosphor light source suitable for high luminance are combined in order to achieve both high luminance and smaller size, there is much unused light, causing generation of discarded light, which is disadvantageous in terms of the efficiency of light utilization. Therefore, a two-plate type projector is being developed. The two-plate type projector typically has a configuration of splitting blue light, which tends to contribute to deterioration of the light valve, into those for two light valves.

In addition, as for the two-plate type projector, it is possible to achieve a smaller projector by using, as a light source, a reflective segmented type phosphor wheel. In the reflective segmented type phosphor wheel, respective color light beams (yellow light Y and blue light B) are supplied to an illumination optical system in a time-sequential manner from two regions of yellow and blue. However, in the reflective segmented type phosphor wheel, a phenomenon occurs in which blue light B′ is present in a mixed manner at the time for yellow light due to surface reflection of the phosphor wheel or scattering phenomenon caused by phosphor particles. This blue light B′ has the same optical path and the same polarization as those of the yellow light Y, and has the same wavelength as that of the blue light B at the time for blue light, and thus is difficult to be split.

Mixing of blue light with red light and green light leads to reduced color gamut. In particular, in association with visual sensitivity, an influence of blue light mixed with red light is more than twice as large as an influence of blue light mixed with green light, and thus greatly reduces the color gamut and significantly lower color reproducibility.

In contrast, in the present embodiment, illumination light emitted from the wavelength conversion section 12 is split by the PBS 31 into the red light R, and the green light G and the blue light B; the red light R is guided to the first light valve 32, and the green light G and the blue light B are guided to the second light valve 33. This, in principle, eliminates a blue light component color mixed with a red light component, as compared with the above-described common two-plate type projector, thus making it possible to increase the color gamut.

As described above, it is possible for the optical module 10 of the present embodiment to improve the color reproducibility of the projector 1 including the optical module 10. That is, it is possible to achieve the projector 1 that is small in size and has high luminance as well as higher color reproducibility.

In addition, in the optical module 10 of the present embodiment, the blue light B is selectively incident on the second light valve 33 on which the green light G is incident, thus making it possible to increase the above-described color gamut as well as to improve a contrast in the blue light B.

Further, the visual sensitivity is high for the green light G, and thus it is essential to keep the contrast to be in a favorable manner. In general, in the optical functional film of the PBS that reflects or transmits incident light depending on the polarization component, the transmission of S-polarized light is kept as low as about 0.1%, whereas, in the transmission of P-polarized light, light exists that leaks out at about 1% to about 2%. In contrast, in the optical module 10 of the present embodiment, the first light valve 32 is disposed for the second surface S2 opposed to the first surface S1, that serves as an incident surface of the illumination light, of the PBS 31, and the second light valve 33 is disposed for the fourth surface S4 opposed to the third surface S3 to which the projection lens 41 is disposed to be opposed, to allow the red light R of P-polarized light to be transmitted by the optical functional film and to allow the green light G (and blue light G) of S-polarized light to be reflected by the optical functional film. Thus, it is possible to improve the contrast of the green light G as well as to further improve the color reproducibility.

Furthermore, on a side of the projection lens 41, a space largely varies depending on a lens to be combined. For example, when using a lens of a large volume structure such as an ultra-short focus lens as the projection lens 41, the first heat sink 51 provided on a side of the second surface S2 of the PBS 31 may interfere with the projection lens 41, in some cases, to cause the cooling efficiency to be rate-controlled. In contrast, in the optical module 10 of the present embodiment, the green light G and the blue light G are incident on the second light valve 33 disposed on a side of the fourth surface S4 opposed to the third surface S3 to which the projection lens 41 is disposed to be opposed. Thus, it is possible to enhance the cooling efficiency of the second heat sink 52 that adjusts the temperature of the second light valve 33 without interfering with the projection lens 41.

Next, description is given of a modification example according to an embodiment of the present disclosure. In the following components similar to those of the foregoing embodiment are denoted by the same reference numerals, and the descriptions thereof are omitted as appropriate

### 2. MODIFICATION EXAMPLE

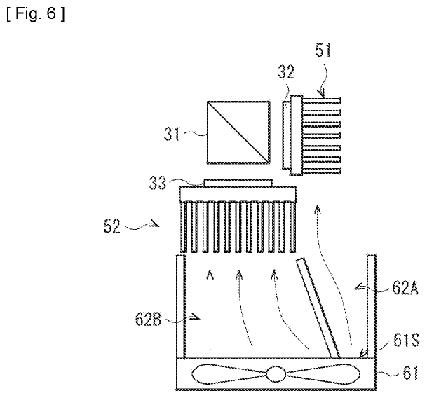

FIG. 5 schematically illustrates an example of a method for cooling two light valves (first light valve 32 and second light valve 33) according to a modification example of the present disclosure. FIG. 6 schematically illustrates another example of the method for cooling two light valves (first light valve 32 and second light valve 33) according to a modification example of the present disclosure

A typical air-cooling system uses a fan having a motor at the middle. At this time, wind does not pass through the middle of the fan, and the flow rate thereof is the largest at a position of the wing. Therefore, in a case of obtaining an effective cooling effect, a cooling target is disposed at the position of the wing.

Meanwhile, in the present modification example, a fan 61 is added, and as illustrated in FIG. 5, the fan 61 is disposed to allow the middle portion of the fan 61, at which the motor is disposed, to be closer to the first light valve 32. This allows more cooling wind to be blown to the second light valve 33 than the first light valve 32. In addition, in the present modification example, as illustrated in FIG. 6, a first duct 62A having an asymmetric opening area and a second duct 62B are provided on a side of a fanning surface 61S of the fan 61. The first duct 62A is opened toward the first light valve 32, and the first duct 62A is opened toward the second duct 62B and has a larger opening area than the second light valve 33. This allows more cooling wind to be blown to the second light valve 33.

Therefore, it is possible to cool the second light valve 33 more intensively than the foregoing embodiment. That is, it is possible to operate both of the first light valve 32 and the second light valve 33 within a more proper temperature range, thus making it possible to achieve the projector 1 having higher color reproducibility.

Although the description has been given hereinabove referring to the embodiment and the modification example, the present disclosure is not limited to the foregoing embodiment and the like, and may be modified in a wide variety of ways. For example, the arrangement, the number, or the like of the components of the optical system exemplified in the foregoing embodiment and the like are merely exemplary; not all the components need to be provided, and other components may further be provided.

In addition, the optical module 10 of the present disclosure can also be used for an apparatus other than the projector. For example, the optical module 10 of the present disclosure may be used as an illumination application; for example, the optical module 10 of the present disclosure is applicable to a light source for lighting up or a headlamp of an automobile.

It is to be noted that the effects described herein are merely illustrative and are not limited to the description, and may have other effects.

The present technology may also have the following configurations. According to the present technology of the following configurations, illumination light including a first color light, a second color light, and a third color light that are emitted from a wavelength conversion section and have different wavelength bands is split by an optical element into the first color light, the second color light, and the third color light, and the first color light is guided to a first reflective light modulation element and the second color light and the third color light are guided to a second reflective light modulation element. This makes it possible to increase a color gamut, and thus to improve color reproducibility.

(1)

An optical module including:
a light source section that emits excitation light;
a wavelength conversion section that emits illumination light including first color light, second color light, and third color light having different wavelength bands by absorption and reflection of the excitation light;
an optical element that splits the illumination light into the first color light, the second color light, and the third color light;
a first reflective light modulation element that modulates the first color light; and
a second reflective light modulation element that modulates the second color light and the third color light.
   (2)

The optical module according to (1), in which the optical element transmits the first color light included in the illumination light and reflects the second color light and the third color light.

(3)

The optical module according to (1) or (2), further including a projection optical system, in which
the optical element has a first surface on which the illumination light is incident, a second surface opposed to the first surface, a third surface adjacent to the first surface and the second surface and opposed to the projection optical system, and a fourth surface opposed to the third surface.
   (4)

The optical module according to (3), in which
the first reflective light modulation element is disposed to face the second surface of the optical element, and
the second reflective light modulation element is disposed to face the fourth surface of the optical element.
   (5)

The optical module according to any one of (1) to (4), further including, between the wavelength conversion section and the optical element, a first wavelength selective polarization conversion element that converts polarized light depending on a wavelength, in which
the first wavelength selective polarization conversion element converts the first color light included in the illumination light into first polarized light, and converts the second color light and the third color light into second polarized light, which is different from the first polarized light, for outputting toward the optical element.
   (6)

The optical module according to (5), further including, between the wavelength conversion section and the first wavelength selective polarization conversion element, a notch filter that transmits the first color light, the second color light, and the third color light, and selectively reflects light of a particular wavelength band between the first color light and the second color light.

(7)

The optical module according to any one of (1) to (6), in which
the wavelength conversion section includes a phosphor region that absorbs the excitation light and emits fluorescence including light of a wavelength different from the excitation light, and a reflective region that reflects the excitation light,
each of the first color light and the second color light includes the fluorescence emitted from the phosphor region, and
the third color light includes the excitation light emitted from the reflective region.
   (8)

The optical module according to any one of (1) to (7), in which
the first color light has a wavelength band corresponding to a red color,
the second color light has a wavelength band corresponding to a green color, and
the third color light has a wavelength band corresponding to a blue color.
   (9)

The optical module according to any one of (1) to (8), in which the optical element includes a polarization beam splitter that splits incident light on a basis of a polarization direction.

(10)

The optical module according to any one of (3) to (9), further including, between the optical element and the projection optical system, a second wavelength selective polarization conversion element that converts polarized light depending on a wavelength.

(11)

The optical module according to any one of (1) to (10), further including a wavelength selective polarization splitting element that is disposed between the light source section and the wavelength conversion section and splits light of a predetermined wavelength band on a basis of a polarization direction.

(12)

The optical module according to (11), further including a ¼ wave plate that is disposed between the wavelength selective polarization splitting element and the wavelength conversion section and rotates polarization directions of the excitation light and the illumination light.

(13)

The optical module according to any one of (4) to (12), in which
the first reflective light modulation element includes a first heat dissipation member on a surface on a side opposite to a surface facing the second surface of the optical element, and
the second reflective light modulation element further includes a second heat dissipation member on a surface on a side opposite to a surface facing the third surface of the optical element.
   (14)

The optical module according to (13), in which the second heat dissipation member has higher heat dissipation performance than the first heat dissipation member.

(15)

The optical module according to (13), in which the second heat dissipation member has a larger heat dissipation area than the first heat dissipation member.

(16)

The optical module according to any one of (13) to (15), further including a fan that blows a cooling wind to the first heat dissipation member and the second heat dissipation member, in which
the fan blows a more cooling wind to the second heat dissipation member than the first heat dissipation member.
   (17)

The optical module according to (16), further including a cooling mechanism that guides the cooling wind to the first heat dissipation member and the second heat dissipation member,
the cooling mechanism including a first duct that guides the cooling wind to the first heat dissipation member and a second duct that guides more of the cooling wind to the second heat dissipation member than the first duct.
   (18)

A projector including an optical module,
the optical module including
   a light source section that emits excitation light,
   a wavelength conversion section that emits illumination light including first color light, second color light, and third color light having different wavelength bands by absorption and reflection of the excitation light,
   an optical element that splits the illumination light into the first color light, the second color light, and the third color light,
   a first reflective light modulation element that modulates the first color light, and
   a second reflective light modulation element that modulates the second color light and the third color light.

This application claims the benefit of Japanese Priority Patent Application JP2021-006955 filed with the Japan Patent Office on Jan. 20, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An optical module comprising:
a light source section that emits excitation light;
a wavelength conversion section that emits illumination light including first color light, second color light, and third color light having different wavelength bands by absorption and reflection of the excitation light;
an optical element that splits the illumination light into the first color light, the second color light, and the third color light;
a first reflective light modulation element that modulates the first color light; and
a second reflective light modulation element that modulates the second color light and the third color light.

2. The optical module according to claim 1, wherein the optical element transmits the first color light included in the illumination light and reflects the second color light and the third color light.

3. The optical module according to claim 1, further comprising a projection optical system, wherein
the optical element has a first surface on which the illumination light is incident, a second surface opposed to the first surface, a third surface adjacent to the first surface and the second surface and opposed to the projection optical system, and a fourth surface opposed to the third surface.

4. The optical module according to claim 3, wherein
the first reflective light modulation element is disposed to face the second surface of the optical element, and
the second reflective light modulation element is disposed to face the fourth surface of the optical element.

5. The optical module according to claim 1, further comprising, between the wavelength conversion section and the optical element, a first wavelength selective polarization conversion element that converts polarized light depending on a wavelength, wherein
the first wavelength selective polarization conversion element converts the first color light included in the illumination light into first polarized light, and converts the second color light and the third color light into second polarized light, which is different from the first polarized light, for outputting toward the optical element.

6. The optical module according to claim 5, further comprising, between the wavelength conversion section and the first wavelength selective polarization conversion element, a notch filter that transmits the first color light, the second color light, and the third color light, and selectively reflects light of a particular wavelength band between the first color light and the second color light.

7. The optical module according to claim 1, wherein
the wavelength conversion section includes a phosphor region that absorbs the excitation light and emits fluorescence including light of a wavelength different from the excitation light, and a reflective region that reflects the excitation light,
each of the first color light and the second color light comprises the fluorescence emitted from the phosphor region, and
the third color light comprises the excitation light emitted from the reflective region.

8. The optical module according to claim 1, wherein
the first color light has a wavelength band corresponding to a red color,
the second color light has a wavelength band corresponding to a green color, and
the third color light has a wavelength band corresponding to a blue color.

9. The optical module according to claim 1, wherein the optical element comprises a polarization beam splitter that splits incident light on a basis of a polarization direction.

10. The optical module according to claim 3, further comprising, between the optical element and the projection optical system, a second wavelength selective polarization conversion element that converts polarized light depending on a wavelength.

11. The optical module according to claim 1, further comprising a wavelength selective polarization splitting element that is disposed between the light source section and the wavelength conversion section and splits light of a predetermined wavelength band on a basis of a polarization direction.

12. The optical module according to claim 11, further comprising a ¼ wave plate that is disposed between the wavelength selective polarization splitting element and the wavelength conversion section and rotates polarization directions of the excitation light and the illumination light.

13. The optical module according to claim 4, wherein
the first reflective light modulation element includes a first heat dissipation member on a surface on a side opposite to a surface facing the second surface of the optical element, and
the second reflective light modulation element further includes a second heat dissipation member on a surface on a side opposite to a surface facing the third surface of the optical element.

14. The optical module according to claim 13, wherein the second heat dissipation member has higher heat dissipation performance than the first heat dissipation member.

15. The optical module according to claim 13, wherein the second heat dissipation member has a larger heat dissipation area than the first heat dissipation member.

16. The optical module according to claim 13, further comprising a fan that blows a cooling wind to the first heat dissipation member and the second heat dissipation member, wherein
the fan blows a more cooling wind to the second heat dissipation member than the first heat dissipation member.

17. The optical module according to claim 16, further comprising a cooling mechanism that guides the cooling wind to the first heat dissipation member and the second heat dissipation member,
the cooling mechanism including a first duct that guides the cooling wind to the first heat dissipation member and a second duct that guides more of the cooling wind to the second heat dissipation member than the first duct.

18. A projector comprising an optical module,
the optical module including
a light source section that emits excitation light,
a wavelength conversion section that emits illumination light including first color light, second color light, and third color light having different wavelength bands by absorption and reflection of the excitation light,
an optical element that splits the illumination light into the first color light, the second color light, and the third color light,
a first reflective light modulation element that modulates the first color light, and
a second reflective light modulation element that modulates the second color light and the third color light.
